(19) United States
(12) Patent Application Publication
(10) Pub. No.: US 2001/0041575 A1
(43) Pub. Date: Nov. 15, 2001

(54) POSITIONING OF GPRS MOBILES USING TOA METHODOLOGY

(76) Inventors: SHAHROKH AMIRIJOO, RICHARDSON, TX (US); BAGHER R. ZADEH, DALLAS, TX (US); BENGT YNGVE PERSSON, DJURSHOLM (SE); TORBJORN OLSSON, HASSLEHOLM (SE)

Correspondence Address: Navarro IP Law Group, P.C., 801 East Campbell Road, Suite 655, Richardson, TX, 75081, US

(21) Appl. No.: 09/195,347

(22) Filed: Nov. 18, 1998

(51) Int. Cl. H04Q 7/20

(52) U.S. Cl. 455/456; 455/457; 455/524

(57) ABSTRACT

A method of positioning a GPRS mobile in a GSM network. Methodology is provided for both Class A, Class B and Class C GPRS mobiles such that the GPRS mobile can be positioned using conventional time of arrival (TOA) methodology. For Class A and Class B mobiles, a new information element in the Paging Message is provided to indicate positioning as the reason for paging. For Class C mobiles, both a new and a modified procedure is provided to facilitate positioning of a GPRS mobile.

### FIELD OF THE INVENTION

The present invention is generally related to wireless communication systems, and more particularly global system for mobiles (GSM) wireless communication systems serving GPRS mobiles.

### BACKGROUND OF THE INVENTION

Wireless communication systems continue to evolve and are currently being deployed in countries throughout the world. There are several types of wireless communication systems currently in service and being deployed including AMPS, D-AMPS, TDMA, CDMA and GSM. These wireless communication systems are currently manufactured by a number of manufacturers, the operation of which are defined by standards groups delegated with the responsibility of ensuring system interoperability. While each of these wireless communication systems may have many common features, the operability of each is unique.

A GSM systems in particular is one of the newer wireless communication systems being developed and deployed. The GSM system is intended to be widely deployed throughout the world to facilitate reliable communications throughout the world. The GSM standards continue to evolve, and are currently being discussed and refined to provide for planned services, as well as services to be developed and employed in future generations. Currently, second generation GSM systems are being deployed while third generation (3G) systems are currently under development with planned implementation scheduled for around the year 2000.

In current GSM systems, positioning of a mobile station (MS) is currently provided in limited situations. Specifically, time of arrival (TOA) based positioning has been selected as the mandatory positioning method by the T1P1.5 standards body, requiring an asynchronous intra-cell handover to the same channel during intra-cell handovers. The reason for this is to force the mobile to transmit access bursts to facilitate an intra-cell handover, whereby the time of arrival of the access bursts are measured by surrounding Location Mobile Units (LMUs). These measurements are used in a triangulation process to pinpoint the mobile's geographical position.

With respect to the GPRS class of mobiles in particular, the intra-cell handover procedure is not suitable as a positioning procedure to locate the geographical position of the mobile. GPRS mobiles don't have the ability to perform the same Intra-cell handover procedure required in the GSM TOA positioning, and thus a solution facilitating positioning the different class of GPRS mobiles is required. The present invention provides for the positioning of GPRS mobiles in a GSM network.

### SUMMARY OF THE INVENTION

The present invention achieves technical advantages as a system and methodology providing for the positioning of GPRS mobiles upon demand in a GSM network. The methodology provides for Class A, Class B and Class C GPRS mobiles to be positioned according to TOA methodology specified in the GSM standards.

According to a first preferred embodiment of the present invention, there is provided a procedure for Class C GPRS mobiles to be positioned using TOA positioning. Several methods are disclosed. According to a first method, a new procedure is provided which can be implemented in future improvements of GSM systems. According to a second method, some existing methodology can be used to take advantage of the existing polling procedures with some modifications.

According to the first method, a positioning command is sent to a GPRS mobile instructing the mobile to send a certain number of access bursts on an assigned radio block of a physical data channel (PDCH). The PDCH channel maybe used by several mobile stations simultaneously. Thus, the network, such as a base switching station (BSS), schedules the uplink radio blocks for different mobiles in a way to assure access to the uplink for the positioned mobile for the required number of consecutive access bursts. The positioning command is sent to the GPRS mobile, which command may include in addition to the channel allocation parameters power control parameters, access burst type, number of access bursts, starting time and also a positioning reference number. During the transmission of the access bursts on the uplink, the mobile monitors the assigned downlink physical associated control channel (PACCH) for new or changed information regarding, e.g. the number of access bursts or power parameters. This feature facilitates the possibility to dynamically change these parameters based on the quality of received access bursts. Continuous Adaptive Timing Advance Procedures will be on-going as specified in the standards during the positioning without any interruption which is valid for both the positioned mobile, and for other mobiles sharing the same PDCH channel. To send the positioning command to the GPRS mobile, a new message is introduced, or, existing messages such as a polling request, uplink assignment, packet time slot reconfigure or immediate assignment messages are modified. The CCU (BSS) is also informed e.g. through in-band signaling CCU-PCU in order to expect access bursts.

According to a second method, the existing Polling procedure of the GPRS mobile is used. In this embodiment, a serving node, such as a base switching station (BSS), polls the GPRS mobile a required number of times. For each polling, the mobile sends four access bursts. The BSS assures access to the uplink of the PDCH during the transmission of the access bursts. Prior to polling, a Temporary Block Flow (TBF) is established using the existing defined procedures in the standards. Alternatively, a TBF already established for the paging response message is used. As in the first method of the present invention, the quality of access bursts are monitored to assist in deciding how many polling requests are required. The output power that is required when sending the access bursts is sent to the positioned MS using the existing system information message prior to, or during, the positioning procedure. As in the previous method, the CCU is informed about the purpose of the accesses. The continuous Adaptive Timing Advance is on-going for both the positioned MS and other MS's sharing the same PDCH. According to a second embodiment of the present invention, Class A and Class B GPRS mobiles are provided with a new information element in a paging message that indicates positioning as the reason for the paging. Responsively, the GPRS mobile then performs a GPRS Suspend procedure, or releases an on-going Temporary Block Flow (TBF) and sets up a normal GSM connection which is used by the network to perform the TOA positioning. Plus A and B GPRS mobiles are adapted to respond to the new information element in the paging message to facilitate the TOA positioning. Alternatively, the Class A and B mobiles can be positioned in GPRS mode using the same method as in Class C mobile. The network may control which mode to be used, i.e. GPRS or normal GSM.

### BRIEF DESCRIPTION OF THE DRAWINGS

FIG. 1 is a block diagram of a typical GPRS logical architecture including a GPRS mobile station to be positioned by a network;

FIG. 2 is a signaling diagram illustrating the initial messaging for positioning a Class C GPRS mobile in the network according to a first methodology;

FIG. 3 is a signaling diagram stemming from FIG. 2 illustrating a new message sequence;

FIG. 4 is a signaling diagram stemming from FIG. 2 illustrating positioning of a Class C GPRS mobile using existing polling procedures with some modifications; and

FIG. 5 is a signaling diagram for positioning a Class A and a Class B GPRS mobile.

### DESCRIPTION OF THE PREFERRED EMBODIMENT

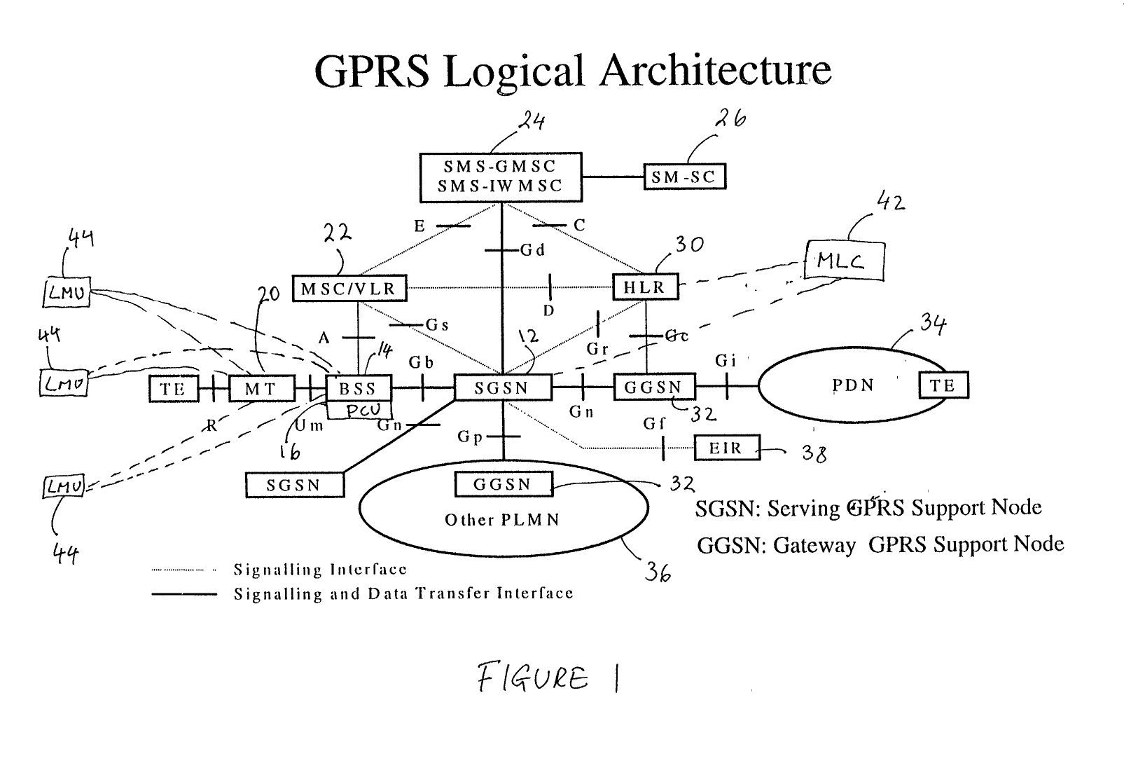

Referring first to FIG. 1 there is shown at 10 a GPRS logical architecture of a GSM wireless communication network. A serving GPRS support node (SGSN) is generally shown at 12 and is seen to service a base switching station (BSS) 14 having combined therewith a Packet Control Unit (PCU) (16). BSS 14 serves a mobile terminal 20 via an RF link, the mobile terminal 20 comprising a GPRS type mobile. A mobile switching center (MSC) 22 having provided therewith a visitors location register (VLR) services the BSS 14. The MSC 22 is interconnected with the SGSN 12 and a short message service (SMS) gateway MSC (GMSC) 24. Functionally coupled to SMS-GMSC 24 is a short message service controller (SMSC) 26. A home location register (HLR) 30 forms another node of the network 10 and is interconnected with the other nodes. HLR 30 is accessible to the SGSN 12. A gateway GPRS support node (GGSN) is seen at 32 and interfaces the SGSN 12 with a PDN 34 for exchanging communication between the GSM network 10 and other networks. Likewise, a separate GGSN 32 may be provided to interface other PLMN to the SGSN 12. An EIR 38 is also connected to SGSN 12, as shown.

The GSM network 10 according to the present invention provides time of arrival (TOA) positioning of the GPRS mobile 20 through the use of a mobile location center (MLC), multiple location measurement unit (LMUs) 44, and 42 in additional messaging parameters to facilitate a Class A, a Class B, and a Class C GPRS mobile to be accurately positioned within the network 10.

### CLASS C MOBILES

According to a first preferred embodiment of the present invention, Class C GPRS mobiles can be geographically positioned through the use of new messages. The new method is advantageous since the existing handover procedures for GPRS mobiles are different than GSM mobiles.

According to a first methodology there is provided a new procedure which can be implemented in future GSM standards. According to a second methodology, an existing Polling procedure can be utilized to take advantage of existing defined procedures in the standards.

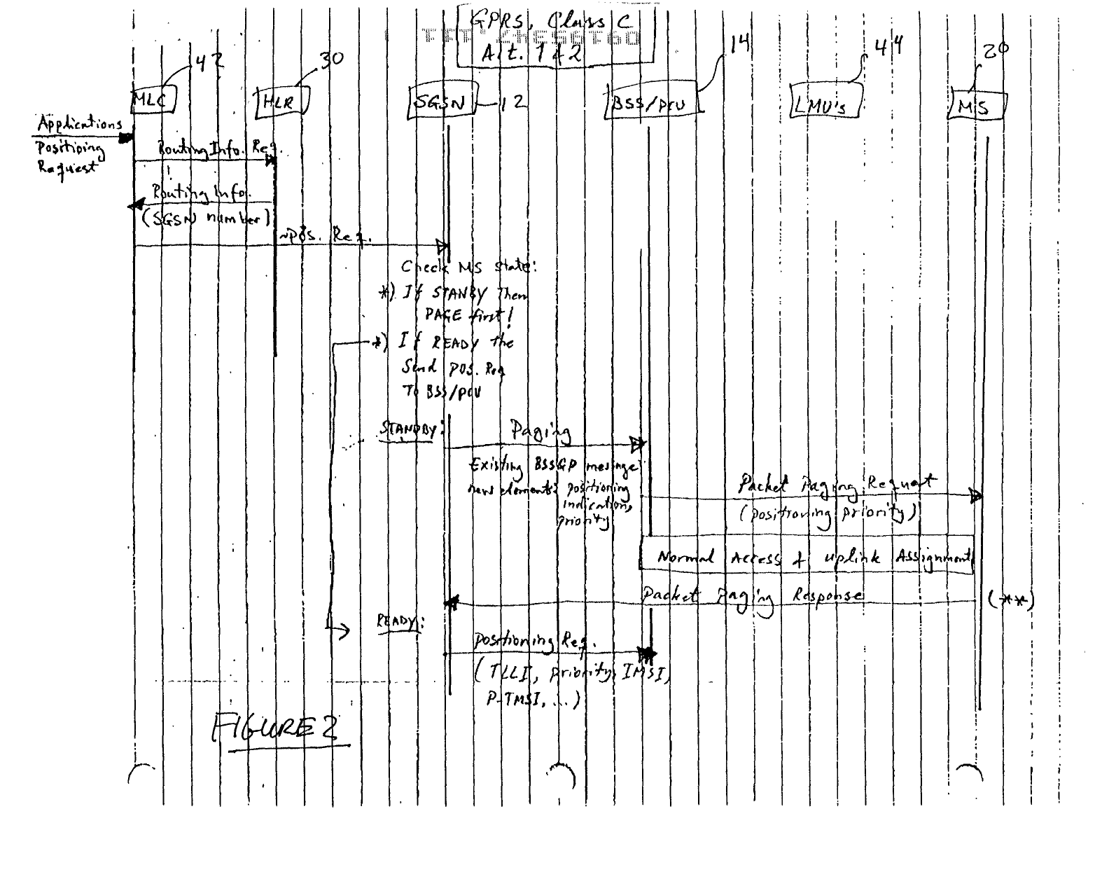

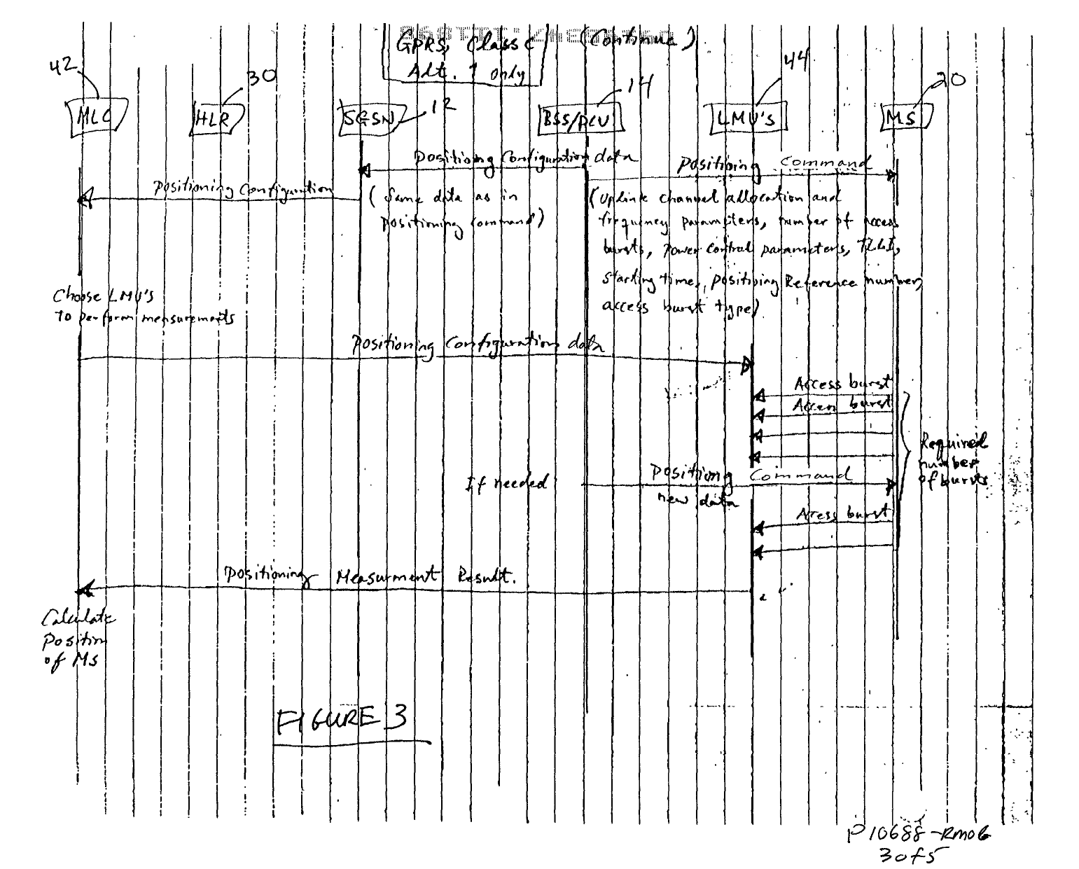

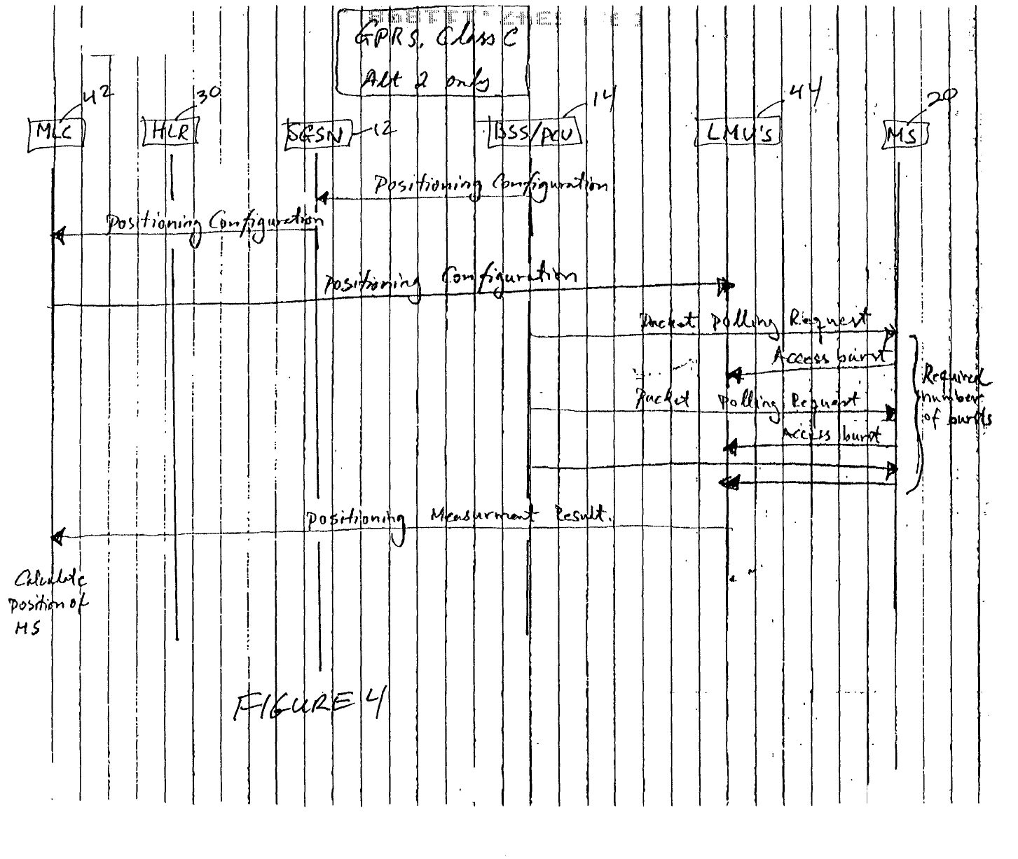

With reference to the flow message diagrams of FIG. 2, FIG. 3 and FIG. 4, there is illustrated a first preferred message flow for providing positioning of a Class C GPRS mobile. FIG. 2 illustrates the initial messages sent within the GSM network 10 that are common to both methods, whereby the messages depicted in FIG. 3 are performed in the first method according to modifications of the standards, and the methodology set forth in FIG. 4 utilizes existing Polling procedures.

First with reference to FIG. 2, the initial messages sent that are common to both methods for Class C mobiles are illustrated. The process begins with the MLC 42 being sent a Positioning Request from an application, such as from a subscriber via PDN 34. Next, the MLC 42 sends a Routing Information Request to the HLR 30 associated with the GPRS 20. The HLR 30 returns Routing Information including the identifying number of the SGSN 12 currently serving the GPRS mobile 20. Using this Routing Information, the MLC 42 then provides a Position Request Message to the SGSN 12 identified as currently serving the GPRS mobile 20.

Next, the state of the GPRS mobile 20 is determined by SGSN 12. If the GPRS mobile 20 currently being positioned is in the Standby Mode, the SGSN 12 sends a Paging message to all BSS/PCU 14 served by the SGSN 12. An existing BSSGP Paging message is sent, having new additional elements including positioning indication and priority parameters. The BSS/PCU 14 responsively sends a Packet Paging Request message to the GPRS mobile 20, including the positioning priority parameters. The GPRS mobile 20 responds with a Packet Paging Response message to the SGSN 12.

If the GPRS mobile 20 is already in the Ready Mode as determined by SGSN 12, the SGSN 12 simply provides the Positioning Request Message to the BSS/PCU 14, including the TLLI, Priority, IMSI, P-TMSI, etc.

Referring now to FIG. 3 and FIG. 4, there are shown two alternative message flow diagrams that both extend from the flow diagram of FIG. 2. The messaging in FIG. 3 illustrates a methodology requiring changes to existing GSM standards, and the methodology of FIG. 4 utilizes messaging using existing messages defined in GSM standards.

First with regards to FIG. 3, upon receiving the Positioning Request Message, the BSS/PCU 14 provides a Positioning Configuration Message to the serving SGSN 12. The serving SGSN 12 responsively provides a Positioning Configuration Message to the MLC 42.

Thereafter, the BSS/PCU 14 generates a positioning command to the GPRS mobile 20 to be located, the positioning command including parameters including: uplink channel allocation, frequency parameters, the number of access bursts to be sent, power control parameters, TLLI, starting time, positioning reference numbers, and access bursts type. Thereafter, the MLC 42 chooses the LMU's 44 to perform measurements based on time of arrival (TOA) techniques by choosing the LMU's 44 proximate the known serving SGSN 12.

The MLC 42 sends Positioning Configuration information to the selected LMUs 44 to expect and process access bursts. Thereafter, the GPRS mobile 20 generates a first continuous series of access bursts of a predetermined number on the assigned radio block of the PDCH channel, such as 4 access bursts in the preferred embodiment of the present invention. The PDCH channel may have been used by several mobiles simultaneously, thus, the network 10, such as BSS 14, schedule the uplink radio blocks for different mobiles in a way to ensure access to the PDCH uplink for the required number of access bursts. The proximate LMUs 44 each receive the access bursts and accurately determine time of arrival of the bursts. The time of arrival information is sent to MLC 42 which performs triangulation positioning according to well known techniques. If needed, a subsequent positioning command with additional data is generated and sent by BSS/PCU 14 to the GPRS mobile 20 to generate an additional set of access bursts. The LMUs 44 receive the access bursts, and forward the time of arrival information to the MLC 42 for processing. The MCL 42 ultimately calculates the position of the GPRS mobile 20 based on the time of arrival information.

According to the methodology collectively illustrated in FIG. 2 and FIG. 3, multiple Positioning commands are generated by the BSS/PCU 14 to the GPRS mobile 20, thereby instructing the GPRS mobile 20 to generate sets of access bursts until the MLC 42 can accurately determine the position of the mobile station 20. The methodology is in a new procedure specifically for positioning a GPRS mobile in a GSM network.

Referring now to FIG. 4, the second methodology using existing messages defined in GSM standards is shown. The message sequence illustrated continues from the messaging of FIG. 2 whereby existing Polling procedures of the GPRS mobile are utilized. After the BSS/PCU 14 receives the Positioning Request in FIG. 2, a Positioning Configuration Message is sent by the BSS/PCU 14 to the particular SGSN 12 currently serving the GPRS mobile 20. The SGSN 12 responsively sends the Positioning Configuration Information to the MLC 42.

The MLC 42 responsively sends the Positioning Configuration Information to the LMUs 44 proximate SGSN 12, instructing the LMUs 44 to be ready to detect access bursts from mobile 20 being paged.

Prior to Polling, a TBF is established using the existing defined procedures in the GSM standards. Alternatively, the TBF established for the Packet Paging Response message can be used. The BSS/PCU 14 then generates a Packet Polling Request message to the mobile station 20. The GPRS mobile 20 responsively generates a first set of access bursts which are detected by the proximate LMUs 44. The BSS 14 assures access to the PDCH uplink during the transmission of the access bursts. A repeated number of Packet Polling Requests are generated by BSS/PCU 14, with responsive access bursts being provided by the GPRS mobile 20. The time of arrive information calculated by the LMUs 44 proximate the GPRS mobile 20 is provided in Positioning Measurement Result messages back to the MLC 42. Thereafter, the MLC 42 determines the position of the GPRS mobile utilizing the time of arrival information according to methodology currently provided in the existing standards.

The methodology provided in FIG. 4 illustrates a method whereby the existing Polling procedures of the GPRS mobile 20 are used. The BSS 14 polls the GPRS mobile 20 a required number of times. For each polling, the mobile station 20 sends a continuous series of access bursts, such as 4 access bursts. The BSS 14 assures access to the uplink of the PDCH during the transmission of the access bursts.

For both methods illustrated in FIG. 3 and FIG. 4, the quality of access bursts are monitored by the LMUs 44, this quality information being provided to MLC 42. The MLC 42 dynamically and responsively determines the number of Polling requests that are required to accurately determine the position of the mobile station 20. Responsively, the output power of the access bursts can be adjusted such that the mobile station 20 adjusts the power level using an existing system information message prior to, or during, the positioning procedure.

In both methods, the BSS 14 is informed about the purpose of the accesses. The continuous Adaptive Timing Advance is on-going for both a positioned mobile station, and also other mobile stations sharing the same PDCH channel. Since the PDCH channel may be used by several GPRS mobiles simultaneously, the BSS schedules the uplink PDCH radio blocks for different mobiles in a way to assure access to the uplink for the positioned mobile for the required number of consecutive access bursts. During the transmission of the access bursts on the uplink, the GPRS mobile 20 monitors the assigned downlink PACCH channel for any new or changed information regarding e.g. the number of access bursts or power parameters. This facilitates the ability to dynamically change these parameters based on the quality of received access bursts.

### CLASS A AND CLASS B MOBILES

Now, with regards to a Class A and Class B GPRS mobile stations 20, the method of the present invention provides a new information element in the Paging Message that indicates from the SGSN to the BSS that positioning is the reason for paging the GPRS mobile station 20. The GPRS Class A and Class B mobiles are able to monitor to control channel of both GSM and GPRS, and thus can be positioned upon demand according to the proposed time of arrival (TOA) method already specified in the GSM standards. However, since Class A and Class B mobiles in the GPRS mode are required to respond to 08.18 CS Paging, via GPRS nodes, or to 08.08 Paging, in order to initiate a positioning procedure, the new information element in the Paging Message is provided to indicate positioning as the reason for paging.

In response to the GPRS Class A and Class B mobile receiving a paging order with a positioning command, the GPRS mobile 20 either performs a GPRS Suspend procedure, or, releases an on-going TBF, and proceeds to set up a normal GSM connection with the GSM network 10. Thereafter, the GPRS mobile 20 is positioned according to the existing TOA procedures defined by GSM standards. Alternatively, the Class A and B mobiles can be positioned in GPRS mode using the same method as in Class C mobile. The network may control which mode to be used, i.e. GPRS or normal GSM.

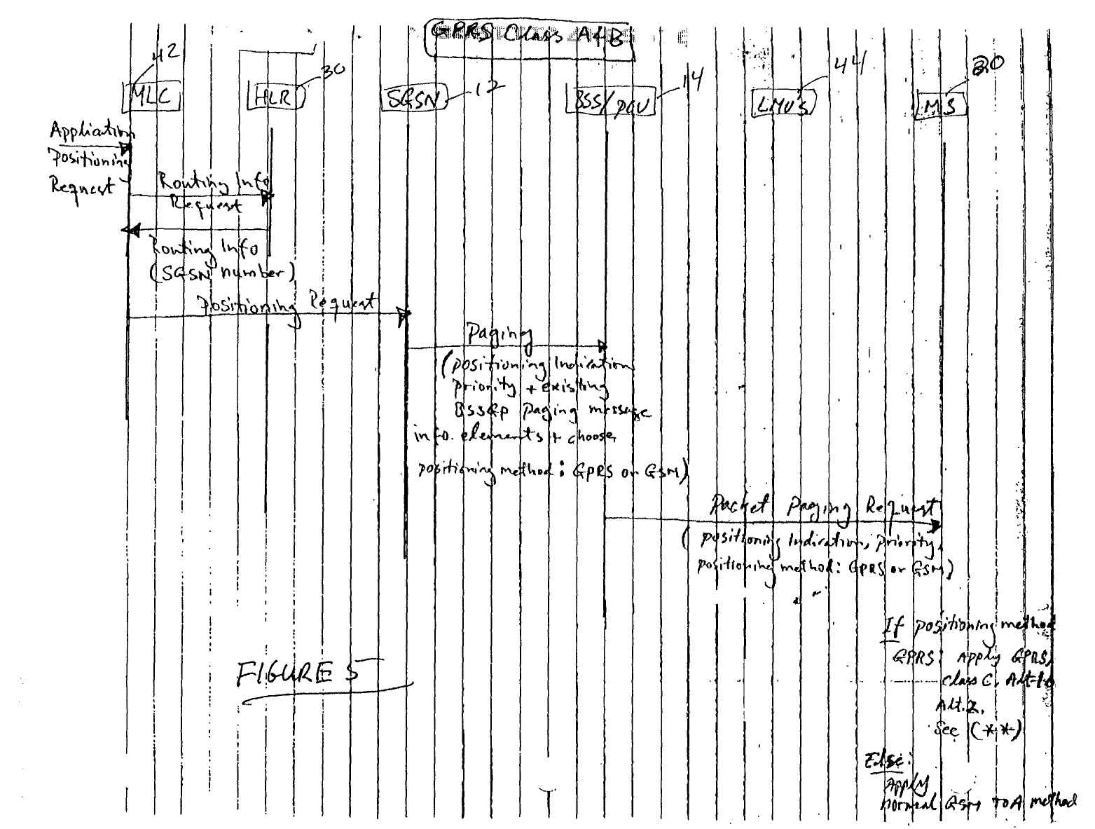

Referring to FIG. 5, there is illustrated a message flow diagram for providing positioning of a Class A and Class B GPRS mobile. According to this methodology, the MLC 42 responds to an application Positioning Request by routing an Information Request Message to the HLR 30 associated with the paged mobile 20. The HLR 30 responsively provides Routing Information including a number identifying the SGSN 12 currently serving the mobile 20.

The MLC 42 responsively provides a Positioning Request Message to the identified SGSN 12 currently serving the mobile 20. The SGSN 12 responsively provides a Paging Message to the serving BSS 14, including positioning indication and priority, in an existing BSSGP paging message having information elements.

The BSS 14 provides a Packet Paging Request Message to the GPRS mobile 20, including the positioning indication, priority, and positioning method i.e. GPRS or GSM mode. If the positioning method indicated is based on GPRS, the methodology continuous by providing a Packet Paging Response as illustrated in FIG. 2 and continuing through FIG. 3.

Alternatively, the mobile 20 may perform the GPRS Suspend procedure, or release an on-going TBF, and set up an normal GSM connection which is used by the network 10 to perform positioning using time of arrival techniques according to existing procedures.

In summary, for Class A and Class B GPRS mobiles, the mobile 20 suspends the GPRS mode and establishes a normal GSM connection to perform conventional TOA positioning. Thereafter, the mobile may return to the GPRS mode after the positioning procedure is complete. The present invention introduces a new information element in the paging message to particularly indicate to the BSS that positioning is the reason for paging. The new information element also introduces whether or not the positioning method is to be based on the GPRS or GSM methodology.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

We claim

1. A method of locating a Class C GPRS mobile in a GSM wireless communications network, comprising the steps of:
a) a serving GPRS node sending a positioning command to the GPRS mobile instructing the GPRS mobile to send a predetermined number of access bursts on an assigned uplink radio block of a PDCH channel; and
b) the GPRS mobile responding to the positioning command by sending the predetermined number of access bursts on the assigned uplink radio block of the PDCH channel.

2. The method as specified in claim 1 further comprising the step of the GSM wireless communications network performing a time of arrival (TOA) positioning process using the received predetermined number of access bursts to determine a position of the GPRS mobile.

3. The method as specified in claim 1 further comprising the step of the GPRS mobile monitoring a downlink PACCH channel for any new information indicative of parameters of the access bursts.

4. The method as specified in claim 3 further comprising the step of the GPRS mobile dynamically changing the parameters of the access bursts as a function of a received new information received on the downlink PACCH.

5. The method as specified in claim 4 wherein the parameters include the number of access bursts to be sent in response to receiving the positioning command.

6. The method as specified in claim 4 wherein the parameters include the power levels of the access bursts.

7. The method as specified in claim 1 wherein the positioning command is sent in a message selected from the group consisting of: existing messages, uplink assignment, packet timeslot reconfigure, and immediate assignment message.

8. The method as specified in claim 2 further comprising the step of sending a message to Location Measurement Units (LMUs) of the GSM wireless communications system to expect the access bursts.

9. The method as specified in claim 2 further comprising the step of a network element of the GSM wireless communications network scheduling the uplink radio block for the GPRS mobile such that the predetermined number of consecutive access bursts on the PDCH channel are sent.

10. The method as specified in claim 1 wherein the serving GPRS node comprises a base switching station (BSS).

11. A method of locating a Class C GPRS mobile in a GSM wireless communications network, comprising the steps of:
a) a serving GPRS node sending a predetermined number of polling messages to a GPRS mobile on a TBF;
b) the GPRS mobile responding to the each polling message by generating access bursts on an uplink PDCH; and
c) determining a position of the GPRS mobile as a function of the received access bursts on the PDCH.

12. The method as specified in claim 11 comprising the step of determining the position of the GPRS mobile in step c) using a time of arrival (TOA) positioning process to the received access bursts on the PDCH.

13. The method as specified in claim 11 further comprising the step of the serving GPRS node determining quality of the received access bursts and performing the steps a), b) and c) again as a function of the determined quality of the received access bursts.

14. The method as specified in claim 11 further comprising the step of the serving GPRS support node scheduling the uplink PDCH such that the consecutive access bursts are sent on the PDCH channel.

15. The method as specified in claim 12 further comprising the step of the GPRS mobile monitoring a downlink PACCH channel for any new information regarding parameters of the access bursts.

16. The method as specified in claim 15 further comprising the step of the GPRS mobile dynamically changing the parameters of the access bursts as a function of a received new information received on the downlink PACCH.

17. The method as specified in claim 16 wherein the parameters include the number of access bursts to be sent in response to receiving the positioning command.

18. The method as specified in claim 16 wherein the parameters include the power level of the access bursts.

19. The method as specified in claim 11 wherein the serving GPRS node comprises a base switching station (BSS).

20. A method of locating a Class A and Class B GPRS mobile in a GSM wireless communications network, comprising the steps of:
a) a serving GPRS node sending a positioning indication, priority level and positioning method to be used in a paging message to the GPRS mobile, the paging message indicating the paging message is for positioning the GPRS mobile;
b) the GPRS mobile setting up a normal GSM connection if GSM is indicated as the positioning method, the GSM wireless communications network performing TOA positioning on the GPRS mobile according to normal GSM TOA method; and
c) performing TOA positioning according to a GPRS Class C method if GPRS is indicated as the positioning method.

21. The method as specified in claim 20 wherein said GPRS mobile performs a GPRS Suspend procedure prior to the step b) and c).

22. The method as specified in claim 20 wherein the GPRS mobile releases an ongoing TBF prior to the step b) and c).

23. The method as specified in claim 20 wherein the GPRS mobile monitors a GPRS control channel, wherein the paging message is provided on the GPRS control channel.

24. The method as specified in claim 20 wherein the GPRS Class C method in step c) comprises the steps of:
a) the serving GPRS node sending a positioning command to the GPRS mobile instructing the GPRS mobile to send a predetermined number of access bursts on an assigned uplink radio block of a PDCH channel; and
b) the GPRS mobile responding to the positioning command by sending the predetermined number of access bursts on the assigned uplink radio block of the PDCH channel.

25. The method as specified in claim 20 wherein the GPRS Class C method in step c) comprises the steps of:
a) the serving GPRS node sending a predetermined number of polling messages to a GPRS mobile on a TBF;
b) the GPRS mobile responding to the each polling message by generating access bursts on an uplink PDCH; and
c) determining a position of the GPRS mobile as a function of the received access bursts on the PDCH.
